(19) United States
(12) Patent Application Publication
(10) Pub. No.: US 2015/0220963 A1
(43) Pub. Date: Aug. 6, 2015

(54) PRE-PAYMENT USES OF TRANSACTIONAL DATA OBTAINED AT THE POINT OF SALE

(71) Applicant: Seth Priebatsch, Boston, MA (US)

(72) Inventor: Seth Priebatsch, Boston, MA (US)

(21) Appl. No.: 14/174,116

(22) Filed: Feb. 6, 2014

(51) Int. Cl. G06Q 30/02

(52) U.S. Cl. CPC G06Q 30/0238; G06Q 30/0268

(57) ABSTRACT

Representative embodiments of a method of electronically providing promotional offers to a consumer at a point of sale include, at a server, electronically receiving, from a merchant device, a consumer-originated transaction request for processing payment to complete the transaction; electronically transmitting, to a plurality of third parties registered with the server, information contained in the transaction request to enable the third parties to formulate promotional offers; and electronically receiving the promotional offers from the third parties and subsequently transmitting at least one of the offers to a mobile device associated with the consumer.

### FIELD OF THE INVENTION

In various embodiments, the present invention relates generally to systems and methods utilizing pre-payment transactional data obtained at the point-of-sale (POS) for various purposes (e.g., modifying transactions).

### BACKGROUND

Merchants and suppliers often use promotional campaigns when marketing their products, providing consumers or business customers with discounts or other incentives to purchase goods or services. The objective of a sales promotion is to induce consumers to test or purchase products. Promotional campaigns include coupons, price reductions, buy-one-get-one-free promotions, contests, and the like. Typically, consumers learn about the promotional campaigns and present coupons to the clerk at a store or enter digital coupon codes on a web portal during the transaction to take advantage of the discounts. But the success of any promotion depends on consumers' awareness of it.

While promotions may sometimes be pre-loaded onto the merchant POS system and automatically provided to a consumer following a transaction (e.g., in the form of a coupon on the receipt), current POS systems have limited capacity for storing promotions. In addition, transactional details (e.g., purchase price) are only available to the merchant operating the POS system; third parties, including product manufacturers, have no access or ability to obtain this information. This may limit the willingness of upstream parties to participate in (i.e., absorb some of the economic impact of) a promotion.

More generally, in conventional promotional schemes, upstream parties (e.g., manufacturers) have limited control over the price of the items, particularly in real time during the transaction, since this is usually set by the merchant. Manufacturer-originated promotional campaigns can be quite expensive because manufacturers, unlike merchants, have few direct ties to consumers; promotions such as mail-in rebates must therefore be heavily advertised with limited ability to target the desired demographic, and must typically offer a substantial economic reward to motivate the consumer to comply with the rebate terms and await payment. Moreover, the economic value of the promotion to the manufacturer may change significantly and in real-time due to the unforeseen launch of competitive products, changes in inventory, and other factors.

Consequently, all parties in the value chain would benefit from the ability to create promotional campaigns that can be easily communicated to consumers, allow control of the promotion's economics in real time, and minimize the burden on consumers to redeem the promotion.

### SUMMARY

In various embodiments, the present invention introduces promotions into the flow of a consumer transaction, enabling manufactures to advance promotions to the consumer based on a current set of purchases. As the consumer is paying for purchases at the POS, for example, the items being purchased may be communicated to manufacturers, who may thereupon offer a promotion to the consumer based on the items purchased or other data. In some embodiments, the manufacturer or other marketplace participant upstream from the merchant, and/or the merchant itself, specifies transactional or other targeting criteria to identify recipients of a promotion. These criteria are stored in a promotions database. The consumer's purchases and/or other data about the consumer are applied as queries to the database before (or concurrently with) transmission of the transaction data to a payment server.

In other embodiments, information regarding the current transaction along with non-transactional and past transactional data from the consumer's records, are provided directly to third parties who register to receive the information during a transaction. For example, third parties may formulate promotional offers in real time based on the received information, and cause these to be provided to the consumer via the POS or by other means. The third parties may thus control the terms of the promotion in real time to accurately reflect, for example, the “value” of the consumer (e.g., the likelihood that he will redeem the promotion and become a repeat customer) as well as the current economics of product promotion (e.g., the real-time value of incentivizing purchase of a particular product).

In still another embodiment, upon receiving the transaction request and the consumer's records, third parties may place promotional bids associated with the current transaction. One or more promotional offers provided by the auction winner(s) is transmitted to the consumer, typically via the POS. Decisions about how many and which offers are provided to the consumer—i.e., the rules of the auction—may be based on, for example, the discount amount, any item-level or seller-level conflict between the offers (e.g., offers for the same type of items from competing manufacturers), the likelihood of offer redemption, the likelihood of affecting the consumer's future purchases, and/or benefits accruing to the consumer and/or the merchant. Accordingly, the current invention provides the consumer with deals likely to be of interest, the merchant with increased sales traffic, and promotion offerors with granular control over the timing and economics.

Accordingly, in one aspect, the invention pertains to a method of electronically providing promotional offers to a consumer at a point of sale. In various embodiments, the method includes steps of, at a server, electronically receiving, from a merchant device, a consumer-originated transaction request for processing payment to complete the transaction; electronically transmitting, to multiple third parties registered with the server, information contained in the transaction request to enable the third parties to formulate promotional offers; and electronically receiving the promotional offers from the third parties and subsequently transmitting one or more offers to a mobile device associated with the consumer. The transmitting step typically occurs prior to electronically sending the transaction request to a payment processor. In addition, if the consumer chooses to redeem the offer(s) via the merchant device, the transaction request may be modified based thereon before electronically sending the transaction request to a payment processor.

Information from records associated with the consumer may be sent to the third parties along with information contained in the transaction request. The transaction request may include a transaction amount and the promotional offers may reduce the transaction amount. In one embodiment, the method further includes the step of compensating the merchant by identifying the third party associated with the promotional offer redeemed by the consumer; and causing transfer of funds from a financial account associated with the identified third party to the merchant. Additionally, the transaction request may include a payment token and the method may further include, at the merchant device, decoding the payment token to determine whether the token is restricted; determining consistency between information contained in the transaction request and restrictions associated with the payment token; and based on the determined consistency, processing or denying the transaction request.

In some embodiments, the method includes computationally analyzing the received promotional offers according to a set of auction rules and the offer(s) transmitted to the mobile device is selected based on the analysis. For example, the auction rules may cause selection of a promotional offer based on (i) a discount amount, (ii) conflicts between the offers, (iii) a likelihood of offer redemption, (iv) a likelihood of affecting the consumer's future purchasing behavior, and/or (v) economic benefits to the consumer, the merchant, and/or the party hosting the server.

In various embodiments, the method includes classifying the third parties and the consumer records into multiple classes; classifying data in the transaction request into one or more classes; and transmitting information contained in the transaction request and records associated with the consumer to only some of the third parties based on the class(es) of data in the transaction request, the classes of the third parties and the consumer records.

In addition, the method may include storing offer rules in a database; computationally determining applicability of the offer rules based on information contained in the transaction request and the records associated with the consumer; retrieving one or more promotions associated with the applicable offer rule(s); and transmitting the promotion(s) to the consumer for redemption. In one embodiment, the method further includes classifying the offer rules into a multiple classes; and classifying data in the transaction request into one or more classes. The applicability of the offer rules is assessed based on the class(es) of data in the transaction request and the classes of the offer rules.

In another aspect, the invention relates to a method of electronically providing promotional offers to a consumer making a purchase transaction at a point of sale and involving one or more items. In various embodiments, the method includes steps of storing, in a database, multiple records each including one or more promotions and a set of trigger criteria associated therewith; electronically receiving, from a merchant device at the point of sale, data specifying elements of the purchase transaction; identifying one or more promotions by querying the database using the received data; and causing the identified promotion(s) to be transmitted to a mobile device associated with the consumer. The elements generally include items purchased and price. In addition, the received data includes information from records associated with the consumer.

Another aspect of the invention relates to a server for electronically providing promotional offers to a consumer at a point of sale. In some embodiments, the server includes the first database for storing records associated with the consumer and the second database for storing records associated with multiple third parties registered therewith; a communication module; and a processor. The processor may be configured to electronically receive, via the communication module from a merchant device, a consumer-originated transaction request for processing payment to complete the transaction; electronically transmit, via the communication module to one or more registered third parties, information contained in the transaction request to enable the third parties to formulate promotional offers; and electronically receive the promotional offers from the third parties and subsequently cause transmission, via the communication module, of one or more offers to a mobile device associated with the consumer. The processor may be further configured to cause transmission, via the communication module, of information to the third parties prior to transmission of the transaction request to a payment processor.

In one implementation, the processor is configured, upon receipt by the communication of a signal indicating a choice by the consumer to redeem the offer(s) via the merchant device, to modify the transaction request based thereon before causing transmission of the transaction request to a payment processor. In addition, the processor may be configured to cause transmission of information from records associated with the consumer to the third parties along with information contained in the transaction request.

In various embodiments, the processor is further configured to compensate the merchant by identifying the third party associated with the promotional offer redeemed by the consumer; and causing transfer of funds from a financial account associated with the identified third party to the merchant.

The server may further include a memory for storing a set of auction rules, and the processor may be further configured to computationally analyze the received promotional offers according to the auction rule; the offer(s) transmitted to the mobile device is selected based on the analysis. Execution of the auction rules by the processor may cause selection of a promotional offer based on (i) a discount amount, (ii) conflicts between the offers, (iii) a likelihood of offer redemption, (iv) a likelihood of affecting the consumer's future purchasing behavior, and/or (v) economic benefits to the consumer, the merchant, and/or the party hosting the server.

Additionally, the processor may be configured to classify the third parties and the consumer records into multiple classes; classify data in the transaction request into one or more classes; and transmit information contained in the transaction request and records associated with the consumer to only some of the third parties based on the class(es) of data in the transaction request, the classes of the third party and the consumer records.

In some embodiments, the processor is configured to store offer rules in the third database; computationally determine applicability of the offer rules based on information contained in the transaction request and the records associated with the consumer; retrieve one or more promotions associated with the applicable offer rule(s); and cause transmission, via the communication module, of the promotion(s) to the consumer for redemption. In one embodiment, the processor is further configured to classify the offer rules into multiple classes; and classify data in the transaction request into one or more classes. The applicability of the offer rules may be assessed based on the class(es) of data in the transaction request and the classes of the offer rules.

In various embodiments, the transaction request includes a payment token and the processor is further configured to decode the payment token to determine whether the token is restricted; determine consistency between information contained in the transaction request and restrictions associated with the payment token; and based on the determined consistency, process or deny the transaction request.

In yet another aspect, the invention pertains to a server for electronically providing promotional offers to a consumer making a purchase transaction at a point of sale and involving one or more items. In various embodiments, the server includes a database for storing multiple records, where each of the records has one or more promotions and a set of trigger criteria associated therewith; a communication module; and a processor. In one embodiment, the processor is configured to electronically receive, via the communication module from a merchant device at the point of sale, data specifying elements of the purchase transaction; identify one or more promotions by querying the database using the received data; and cause the identified promotion(s) to be transmitted, via the communication module, to a mobile device associated with the consumer.

Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1 is a block diagram of an exemplary network in accordance with an embodiment of the invention;

FIGS. 2A and 2B are block diagrams of an exemplary mobile device and transaction server, respectively, in accordance with an embodiment of the invention;

FIG. 3 is a block diagram illustrating an approach for applying a promotional offer to the current transaction in accordance with an embodiment of the invention;

FIGS. 4A-4C are workflow diagrams that illustrate providing a promotional offer to the consumer in accordance with various embodiments of the invention;

FIG. 5 is a block diagram illustrating an approach for applying restrictions to a payment token in accordance with an embodiment of the invention; and

FIG. 6 is a workflow diagram illustrating the application of payment token restrictions in payment transactions in accordance with an embodiment of the invention.

### DETAILED DESCRIPTION

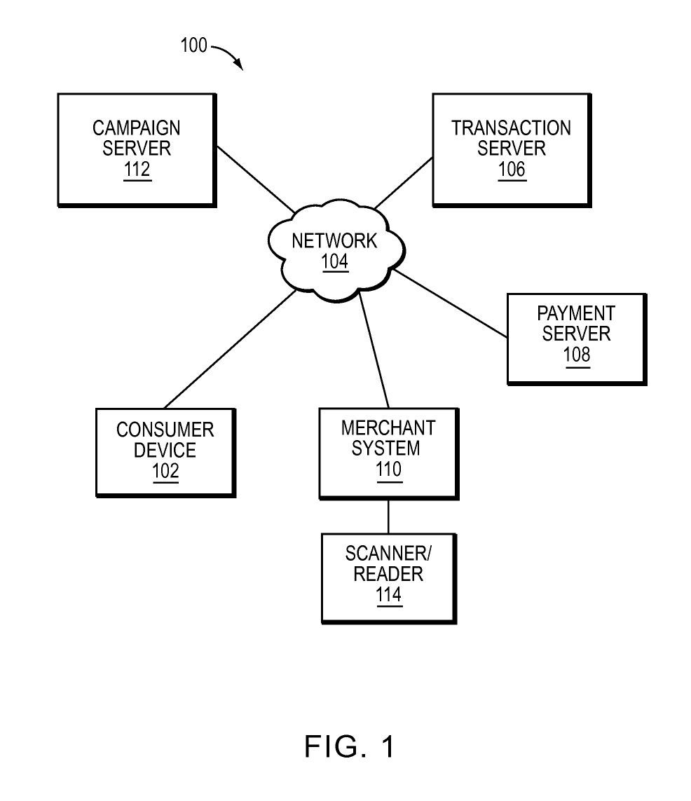

Refer first to FIG. 1, which depicts an exemplary mobile-payment transaction network 100 including a consumer device (e.g., a mobile device) 102 linked to other systems via a network 104 that supports wired, wireless, or any two-way communication (e.g., a cellular telephone network, the Internet, or any wide-area network or combination of networks capable of supporting point-to-point data transfer and communication). The network 104 connects various devices, including a transaction server 106, a payment processor 108, one or more merchant systems 110, and one or more campaign servers 112 as described in greater detail below. Each merchant system 110 may be associated with a merchant who offers goods or services for sale to the consumer device 102. In one embodiment, the merchant system 110 is a point-of-sale (POS) system (e.g., an electronic cash register) that connects to a code reader or scanner (hereafter “reader”) 114. The reader 114 may be mobile or physically associated with the merchant system 110 and may be capable of reading and/or decoding a payment token presented as, for example, a barcode, a radiofrequency identification (RFID) code, or a “Quick Response” (QR) code, and/or receiving signals, such as NFC signals, audio signals, or infrared signals transmitted from the consumer's device 102. The merchant system 110 transmits the received payment token and transactional details (e.g., purchased items, transaction amount, transaction date/time, merchant type, etc.) to the transaction server 106 to verify or authorize the transaction. When receiving the requested transaction, the transaction server 106 determines whether one or more real-time discounts are available in the manner described below and transmits the offered discount(s) to the merchant system 110, or in some embodiments, directly to the consumer device 102. If the consumer decides to take advantage of the offer(s), the transaction server 106 then transmits the payment token and transaction details with a discounted price to the payment server 108 for approval, or in some embodiments, grants the payment request.

The payment processor 108 may be responsible for actually performing the payment transaction and, in some cases, for decrypting the payment token. For example, a so-called “direct” payment processor represents the financial-processing backend provider to credit-card issuers and payment services such as PAYPAL. An “indirect” payment processor is an independent entity processing transactions for multiple payment services and maintains its own records and data. In various embodiments, upon receiving the transaction request, the transaction server 106 transmits the transactional data and/or non-transactional data to the campaign server(s) 112, enabling the campaign servers to formulate one or more offers in real-time as further described below. The offer(s), again, may be presented to the consumer directly via his device 102 or indirectly via the merchant system 110.

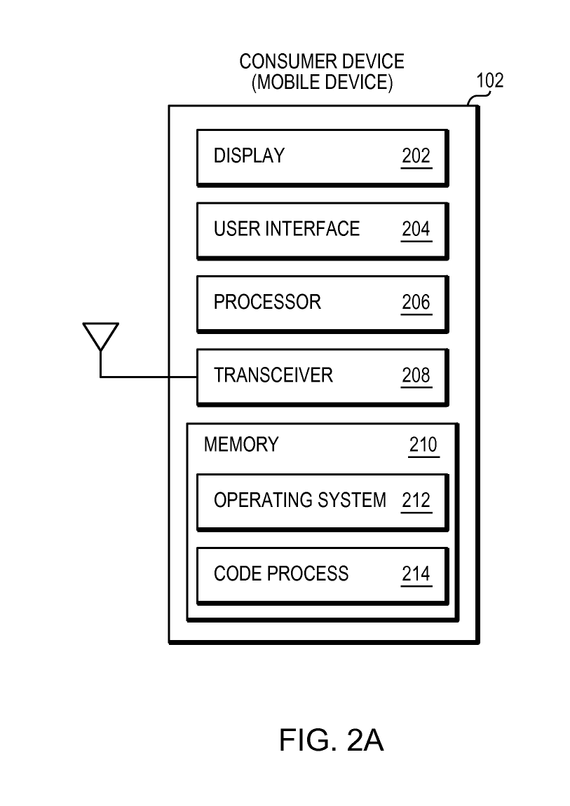

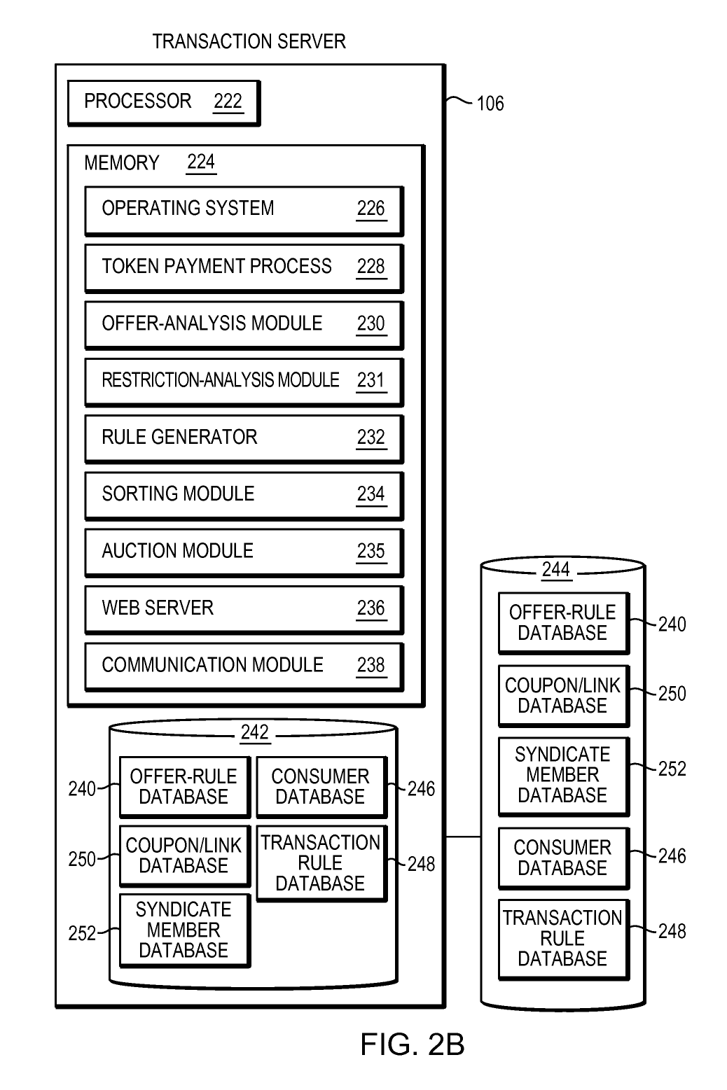

The mobile device 102 acts as a gateway for transmitting the consumer's data (e.g., the payment token) to the network 104. The mobile device 102 can support multiple communication channels for exchanging multimedia and other data with the transaction server 106 and other devices using a Wi-Fi LAN (e.g., IEEE 802.11 standard) for Internet access, a short-range Bluetooth wireless connection for point-to-point access, and/or an NFC channel for close-proximity access. Referring to FIG. 2A, in various embodiments, the mobile device 102 includes a conventional display screen 202, a user interface 204, a processor 206, a transceiver 208, and a memory 210. The transceiver 208 may be a conventional component (e.g., a network interface or transceiver) designed to provide communications with a network, such as the Internet and/or any other land-based or wireless telecommunications network or system, and, through the network, with the transaction server 106. The memory 210 includes an operating system (OS) 212, such as GOOGLE ANDROID, NOKIA SYMBIAN, BLACKBERRY RIM or MICROSOFT WINDOWS MOBILE, and a token process 214 that implements the device-side functions for transmitting, receiving and/or generating the payment token. Additional transactional information may be embedded in the token process 214 for transmission through the network 104 for later processing on a back-end server (e.g., the transaction server 106). As used herein, the term “mobile device” used for transacting a mobile payment refers to a “smart phone” or tablet with advanced computing ability that, generally, facilitates bi-directional communication and data transfer using a mobile telecommunication network, and is capable of executing locally stored applications and/or payment transactions. Mobile devices include, for example, IPHONES (available from Apple Inc., Cupertino, Calif.), BLACKBERRY devices (available from Research in Motion, Waterloo, Ontario, Canada), or any smart phones equipped with the ANDROID platform (available from Google Inc., Mountain View, Calif.), tablets, such as the IPAD and KINDLE FIRE, and personal digital assistants (PDAs). The memory 210 may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit.

Referring to FIG. 2B, in some embodiments, the transaction server 106 includes a processor 222, a memory 224 having an operating system (OS) 226, a token payment process 228, an offer-analysis module 230, a restriction-analysis module 231, a rule generator 232, a sorting module 234, an auction module 235, a web-server block 236, a communication module 238 and a storage device 242. The token payment process 228 implements the server-side functions of transmitting, receiving, generating and/or decoding the payment token. Approaches for generating a secure payment token are described in, for example, U.S. Ser. No. 13/718,466, filed on Dec. 18, 2012, and Ser. No. 13/960,260, filed on Aug. 6, 2013, the entire disclosures of which are hereby incorporated by reference.

In some embodiments, the offer-analysis module 230 determines whether the requested transaction qualifies for one or more promotional offers based on offer rules associated with offers stored in an offer database 240 that resides in a local storage device 242 and/or an external mass-storage device 244 accessible to the transaction server 106 as further described below. In some embodiments, the offer rules are provided by the campaign servers 112 of third parties prior to or during the transaction. When the merchant system 110 (see FIG. 1) submits a transaction request for payment, it is first transmitted to the transaction server 106. In some embodiments, the offer-analysis module 230 analyzes the transaction request, the offer rules, and/or the consumer's profile and records (containing historical transactional and/or non-transactional data) stored in a consumer database 246 to determine which, if any, promotional offer(s) are applicable to the requested transaction. When there are multiple offers whose offer rules are satisfied by the current transaction, in one embodiment, the offer-analysis module 230 identifies the best deal (e.g., having the largest discount) and presents it to the consumer by transmitting it, via the network 104, to the consumer's device 102. In another embodiment, the offer-analysis module 230 transmits all applicable offers to the consumer. The consumer approves and/or selects the desired offer(s) and communicates his decision to the transaction server 106. Upon receiving the communication from the consumer, and assuming it reflects acceptance of the offer, the offer-analysis module 230 modifies the current transaction (e.g., updating the price to reflect the accepted offer) and transmits the modified transaction request to the payment server 108 for approval, or, in some embodiments, authorizes the modified transaction directly. In other embodiments, once the applicable offer(s) are identified, the offer-analysis module 230 automatically modifies the transaction to redeem the offer(s) without the need for the consumer's approval. In various embodiments, after completion of the current transaction, the offer-analysis module 230 analyzes the completed transaction, the offer(s) approved/selected by the consumer, and/or the transactional rules to identify offers for potential future transactions based on the offer rules. The offer-analysis module 230 transmits the identified offer(s) to the consumer as an incentive for future purchases. The offer(s) may be transmitted to the consumer device 102 in the form of, for example, a coupon or a link that directs the consumer to retrieve the offer(s). The coupon or link may be stored in a coupon/link database 250 in the storage devices 242, 244. In addition, the transmitted or retrieved coupon may be formatted as a code (such as, a barcode, an RFID code, or a QR code, and/or a signal, such as an NFC signal, an audio signal, or an infrared signal) readable to the reader 114 in the merchant system 110.

In one embodiment, the sorting module 234 classifies the consumer's records, including transactional and/or non-transactional data and the offer rules into multiple classes prior to a transaction to facilitate offer analysis. Transactional classes may be drawn from earlier consumer purchases, and may correspond to categories of goods purchases by the consumer within a recent time period, and may also be sorted by attributes such as price, merchant, merchant location, etc. Non-transactional classes may include demographic data known about the consumer, e.g., age, gender, address, etc. During the current transaction, the sorting module 234 assigns data from the transaction request to one or more classes. Applicability of the offer rules to the current transaction is then evaluated by the offer-analysis module 230 on a class-by-class basis (with the various classes weighted, if desired) to simplify the analysis.

In some embodiments, third parties may register offers with the transaction server 106. These offers are stored in an offer database 240, and may be withdrawn and/or modified as desired by the third-party offer providers. The offers in the offer database 240 (in their current form) are evaluated as described above, and once again, one or more offers (e.g., the best deal) satisfying the offer rules are provided to the consumer. In alternative embodiments, third parties may provide offers in real time based on the current transaction as well as, in some embodiments, historical transactional and/or non-transactional data for the consumer. These offers may be assessed and filtered in any of various ways. For example, the memory 224 may contain an auction module 235 that allows offer providers to bid, in real time, for the privilege of providing an offer to the consumer. In such embodiments, data reflecting the current transaction (e.g., goods purchased and price), and optionally historical transactional and/or non-transactional data for the consumer, are transmitted to offer providers registered with the transaction server 106. Interested offer providers submit bids to the transaction server 106 reflecting how much they are willing to pay to have their offer presented to the consumer; this amount may be staged to reflect, for example, a first fee for transmission of the offer and a second fee if the consumer actually redeems the offer. The first fee can be tiered so that the offer provider has the option of bidding a higher amount for exclusivity, i.e., to preclude other offers from being simultaneously provided to the consumer. The auction module 235 assesses the bids as well as item-level and/or source-level conflicts (in some embodiments to prevent two offers for competing items from being simultaneously present to the consumer, for example, or in other embodiments to present such competing offers). All of this occurs prior to submission of the transaction for payment. Depending on the nature of the offer(s), they may be redeemed immediately by the consumer, in which case the transaction is modified before submission for payment, and/or may simply be supplied to the consumer's mobile device for future use.

More specifically, in auction implementations, the auction module 235 provides information associated with the current transaction and/or the consumer's records to the campaign servers 112 of the third parties, which are typically syndicate members registered with the transaction server 106. The campaign servers 112 place their promotional bids associated with the current transaction; the auction module 235 then determines at least one auction winner based on, for example, the discount amount for the current transaction. The offer(s) from the auction winner(s) is then transmitted to the consumer for approval or selection. Records associated with the syndicate members may be stored in a syndicate member database 252 in the storage devices 242, 244. Conducting the auction during the transaction allows a third party to modify the offer and select a bid amount that reflects current business conditions and strategic priorities. Accordingly, the current invention provides the consumer with an improved deal, the merchant with sales traffic, and the third-party participants with control over the incentive. Although the discussion herewith focuses on auctions including promotional offers related to the current transaction, bids may contain promotions for future purchases. In one embodiment, only the bid from the bid winner is transmitted to the consumer. In another embodiment, some or all bids relating to future purchases are passed on to the consumer.

In various embodiments, in response to a request to process the transaction, the restriction-analysis module 231 analyzes the transaction request, information decoded from the payment token, the consumer's profile and records, and/or the transactional rules associated with the consumer that are stored in the transactional rule database 248 and determines whether the payment token is restricted and whether information contained in the requested transaction is consistent with the restrictions defined by the transactional rules. If the transactional rules are satisfied, the transaction server 106 passes the transaction request to the payment server 108 for authorization or, in some embodiments, approves the transaction. If, however, the transactional rules are violated, the transaction server 106 denies the transaction request. The transactional rules may be defined by the consumer or a third party and/or created by the rule generator 232 based on consumer records stored in the consumer database 246 and/or collected from an external source (e.g., social media sites).

The web-server block 236 enables web-based communication with the mobile device 102, the payment processor 108, and the campaign servers 112, and can be a conventional web-server application executed by the processor 222. The communication module 238 may be a conventional component (e.g., a network interface or transceiver) designed to provide communications with a network, such as the Internet and/or any other land-based or wireless telecommunications network or system, and, through the network, with the mobile device 102. The databases 240, 246, 248, 250, 252 and/or the campaign servers 112 are responsive to queries from the offer-analysis module 230, the rule generator 232, and the sorting module 234.

In a typical operation, prior to a transaction, a third party (such as the product manufacturer, advertiser, other marketplace participant upstream from the merchant, the merchant itself, or any party interested in sales conducted via the transaction server 106) registers an account with the transaction server 106 via its campaign server 112 to enable the third party to offer promotions to the consumer during a transaction, or to post promotions to the offer database 240. Offer rules provided by the campaign servers 112 of the third parties may be continuously updated, or may be updated periodically, e.g., nightly, using, for example, a web crawler. The updated offer rules may then be transmitted downstream to the merchant POS systems for expediting checking processes. The third party may provide at least one financial account or create a deposit account with the transaction server 106 to which any difference in the transaction amount resulting from the offered promotion(s) that is ultimately applied in favor of the consumer will be charged. Upon successful registration, the third party may be assigned a unique identifier tied to the financial or deposit account and represented by a record stored in the syndicate member database 252. The third party may specify transactional or other targeting criteria to identify recipients of a promotion, thereby formulating offer rules defining when, what and to whom a promotion will be offered; the offer rules are stored in the offer database 240. The consumer's purchases and/or other data about the consumer are gathered via queries to the database 246 before (or concurrently with) transmission of the transaction data to a payment server. The consumers may or may not sign up with the transaction server 106 in order to receive the offers (e.g., promotions, discounts, sweepstakes, reward points, direct mail coupons, email coupons, etc.).

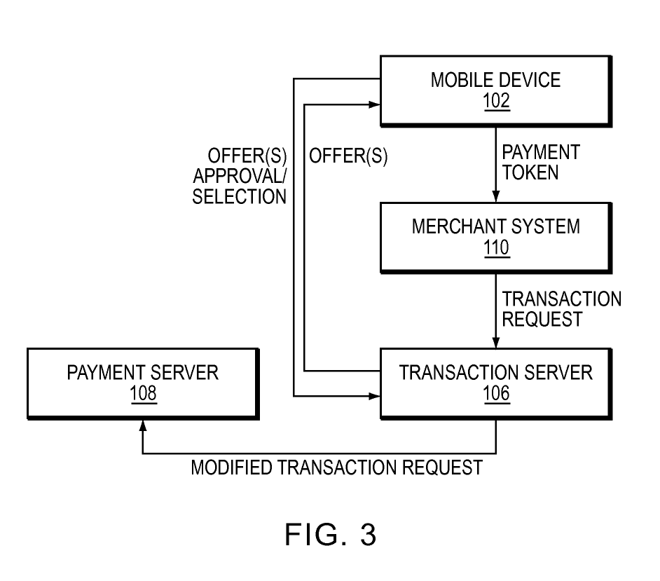

Referring to FIG. 3, during a transaction, the consumer first presents a payment token stored in the mobile device 102 to the merchant system 110; the payment token may include data identifying the mobile device 102 and/or the consumer's payment instrument (e.g., a credit card, a bank account, or a pre-loaded payment card). The merchant system 110 transmits the payment token together with payment data (e.g., purchased item (a good or a service), amount, and the time and name or merchant category code of the merchant) to the transaction server 106 (directly or via the payment server 108) to request processing of the transaction. The transaction server 106 decodes the token using the token payment process 228 and matches the information therein to the consumer's records stored in the database 246 to identify the consumer. In some embodiments, the offer-analysis module 230 analyzes the transactional details against the offer rules stored in the database 240 and the consumer's records, including transactional and/or non-transactional data, stored in the consumer database 246 to determine the applicability of the offer rules to the requested transaction. For example, in a transaction involving a soft drink, the offer-analysis module 230 may search for an offer in the database 240 relevant to soft drinks when receiving the request from the merchant POS system 110. The offer-analysis module 230 may identify a promotional rule that offers, for example, a free drink for every ten purchases of products provided by the soft drink manufacturer, brand K. The offer-analysis module 230 then accesses the consumer's database 246 to determine whether the current purchase is the tenth purchase. If so, the coupon or link associated with the applicable offer is transmitted to the consumer device 102 directly or indirectly via the merchant system 110. If the consumer chooses to redeem this offer, the transaction server 106 modifies the payment request and transmits it to the payment server 108 for authorization (and, in some embodiments, directly transfers funds from brand K's deposit account to the merchant). In some embodiments, upon identifying the offer, the offer-analysis module 230 modifies the payment request to automatically redeem the offer without the need for the consumer's approval. The consumer simply receives a message regarding the free drink awarded by the manufacturer. The current invention thus obviates the need for the consumer to learn about the offer prior to the transaction and/or take additional steps beyond the current transaction to redeem the offer.

The consumer's records may include both transactional and non-transactional data. The transactional data may be obtained from previous transactions handled by or informationally accessible to the transaction server 106, including purchased items (i.e., goods and/or services), transaction amounts and time, names or merchant category codes of the involved merchants, account numbers, approval or denial information, etc. The non-transactional data is any data not directly derived from previous transactions but relevant to the consumer's behavior or status. For example, the non-transactional data may include membership status in various organizations (e.g., an animal-rights organization, Sierra Club, Humane Society, National Rifle Association, etc), a medical history, habits, preferences and dislikes, demographics, etc.

Promotional offers may be provided by any party interested in the consumer and/or the item(s) sought to be purchased. For example, a second soft-drink manufacturer, brand A, may offer an 80% discount to a consumer who has no record of purchasing brand A's products and has requested a transaction payment involving the competitor's (brand K's) soft drinks. In other words, the offers may be triggered by a transaction request involving products from the competitors. Again, the offer-analysis module 230 may identify this promotional rule in the offer database 240 and determine the applicability of the associated offer based on the consumer's record stored in database 246. If the consumer qualifies for this promotional rule, the transaction server 106 may transmit the coupon or link associated with the offer to the consumer, who, in turn, may choose to redeem the offer in the current or future transaction. If the consumer redeems the offer, the transaction server 106 modifies the requested transaction amount received from the merchant by reducing the list price by 80% and subsequently transmits the discounted price (i.e., 20% of the listing price) to the payment server 108 for approval. In addition, the transaction server 106 may request the payment server 108 to authorize a payment of the price difference between the original and modified transaction requests from the third party's financial account to the merchant, who thereby receives full payment. In some embodiments, the transaction server 106 directly authorizes the modified transaction request and compensates the merchant by transferring funds from the third party's deposit account registered therewith to the merchant. The promotional offer may involve various types of products different from the item(s) sought to be purchased. In the example of purchasing a soft drink, the consumer may receive an offer from a pizza manufacturer with a 10% discount of its pizza if bought together with the soft drink in the current transaction. Once again, if the consumer chooses to redeem this offer, the transaction server 106 modifies the requested transaction amount and compensates the merchant for the price difference resulting from the promotional offer by, e.g., requesting/directing a payment from the pizza manufacturer's account to the merchant. Accordingly, the current invention facilitates the organization of promotional campaigns that can be easily communicated to the consumer and which may or may not be visible to the merchant.

Additionally, the promotional offer may be associated with the consumer's non-transactional data (e.g., demographics). For example, a milk manufacturer may offer a discount to consumers who have young children; analysis of this offer rule may be triggered when the consumers purchase groceries. When the transaction server 106 receives the transaction request involving grocery shopping, the offer-analysis module 230 may search for offers relevant to groceries, thereby identifying the offer provided by the milk manufacturer. The offer-analysis module 230 subsequently searches the consumer's demographic information to the extent known, and assuming access to the consumer's family demographics, a coupon/link associated with the promotion provided by the milk manufacturer may be transmitted to the consumer. Accordingly, the offer rules may be formulated based on any data associated with each consumer “known” to the transaction server 106 (e.g., because the consumer has signed up for an account in order to receive promotional offers) at the time of receiving the transaction request. The records may be stored in the consumer database 246. In some embodiments, information about the consumer may be collected from social media sites using the web-server block 236 or communication module 238. The social media sites may include or communicate with collaborative projects (e.g., WIKIPEDIA), blogs or microblogs (e.g., TWITTER and PINTEREST), content communities (e.g., YOUTUBE), social networking sites (e.g., FACEBOOK and GOOGLE+), online newspapers, event calendars, message boards, or any one, or combination of, network-based applications utilized by the consumer and which provide useful consumer-specific information for analysis of the offer applicability. Information can be accessed or retrieved from the social media sites in various ways. For example, web crawlers may be used to access social media postings and analyze entries or textual postings for relevant information to glean the information in an automated fashion (see, e.g., U.S. Pat. No. 8,352,406). In addition, the transaction server 106 may acquire the consumer's information by subscribing to various media sites using well-known approaches, such as really simple syndication (RSS) feeds, API accesses, etc.; see, e.g., U.S. Ser. No. 14/107,677, filed on Dec. 16, 2013, the entire disclosure of which is hereby incorporated by reference.

The offers applicable to the consumer in the current or a future transaction may be exclusive or combinable. In one embodiment, the third-party participants in the promotional campaigns determine whether their offers are combinable with other offers of their own and/or provided by other parties, and may pay a premium to keep their offers exclusive; these decisions are stored in the rule database 240. In another embodiment, the decision is made by the transaction server 106 based on, for example, the discount amount, conflicts between the offers (e.g., offers to the same type of items from different manufacturers), the likelihood of offer redemption, the likelihood of affecting the consumer's future purchase, and/or the benefits to the consumer, the merchant, and/or the party hosting the transaction sever 106. For example, all offers having no conflicts (e.g., involving unrelated types of items) may be transmitted to the consumer. If there is a conflict among different offers (e.g., the same type of product from different manufacturers), the transaction server 106 may transmit only the offer giving a bigger discount to the consumer. In some embodiments, the transaction server 106 transmits offers having a conflict such that the consumer is aware of the competitor's offers and has more options for the same type of products. In addition, offers provided to the consumer may be changed in accordance with his behavior. For example, the offer-analysis module 230 may assign a ranking score to each applicable offer based on the consumer's records, including, for example, categories of items purchased, categories of promotions offered and redeemed in the past, and/or the consumer's reviews of the items and manufacturers and/or the geometrical relationship between the consumer's current location and the locations where the offers can be redeemed. The transaction server 106 may then transmit one or more offers having the highest ranking scores to the consumer. The analysis module 230 may periodically examine consumer transactional behavior to adjust the rankings and the associated scores. For example, if the consumer claims and/or redeems a specific offer, a higher ranking score may be assigned to the same or similar offer for the same type of item and/or from the same third party participant in the next transaction.

In various embodiments, the selection of promotional rules for a given transaction is made by the sorting module 234. In these embodiments, a consumer's records, including transactional and non-transactional data, and the offer rules are classified into multiple classes. These classes may be predetermined or may be identified by a conventional learning/training algorithm for classifying data applied to the consumer's records and the offer rules. During a transaction, the item(s) sought to be purchased (and/or other attributes of a transaction) is assigned to one or more previously defined classes. Identification of the applicable offers associated with the item(s) may thus operate at the level of an item class rather than at the much more granular item level, thereby simplifying the analysis of offer applicability—i.e., the offer-analysis module 230 searches for promotional rules in the assigned item class(es) associated with the current transaction without the need to search for promotional rules among vast listings of items. Each class may include multiple sub-classes. For example, in an item class called “clothing,” there are sub-classes called “apparel,” “accessories,” “lingerie,” etc. The number of classes and sub-classes reflect a trade-off between computational convenience and the accuracy of assessing the offer applicability. For example, items associated with basic needs (e.g., food) are purchased more frequently and thereby may have more offers associated therewith than items that are infrequently purchased, such as vehicles, so sub-classes may be chosen to reflect these differences in the number of available offers.

Classes involving the consumer's transactional records may include, for example, type of items (goods or service), dates and time of purchase, etc.; similarly, classes involving non-transactional records may include, for example, the consumer's preference data (such as preferred food or color derived from, for example, postings to a social media site), religious affiliation or membership status in one or more organizations associated with preferences having transactional implications, the consumer's current location, medical history, etc. Additionally, non-transactional data may include environmental information, such as the weather conditions.

In various embodiments, the third-party syndicate members register with the transaction server 106 to receive information associated with the current transaction and/or the consumer's records during a transaction in order to formulate one or more offers in real time. This allows the third party to control the product price to accurately reflect its business strategies or changes in inventory in real time. For example, upon receiving an announcement of launching a new-generation product from the manufacturer, the accessory suppliers of the older-generation product may provide promotions to the consumers who seek to purchase the older-generation product or other types of accessories associated with the older-generation product in the current transaction; the promotions are then offered to the consumers via the transaction server 106. This helps the third party (i.e., the suppliers in this example) timely develop a strategy to efficiently sell the products in accordance with real-time conditions to avoid overstocking. In some embodiments, the offers include incentives (e.g., credits) to the consumers for broadcasting the promotions to their families and friends. Once again, the real-time offers may be exclusive or combinable as determined by the third parties and/or the transaction sever 106 as described above.

In addition, the transaction server 106 may rank the offers and determine the number of offers and/or which offers will be directed to the consumers. In various embodiments, the third-party syndicate members are classified into multiple classes. The transaction server 106 transmits information associated with the requested transaction and consumer only to some of the members based on the class(es) of data in the transaction request and the classes of the third parties and the consumer records. For example, when the purchased items are classified into the “grocery” class, the transactional data is transmitted only to third parties who are classified in the class of grocery manufacturers; third parties classified as other classes (e.g., vehicle manufacturers) may not receive the transaction information. Alternatively, syndicate members may select classes for notification purposes, so that they receive transactional information and an opportunity to provide offers (or to bid on providing offers) when transactions within the selected classes occur.

The consumer may receive promotional offers for the items sought to be purchased (and/or other items relevant thereto) prior to presenting them to the merchant system 110. In various embodiments, the consumer first launches an application on the mobile device 102 to scan the barcodes of the items of interest. The mobile device 102 then transmits the scanned information to the transaction server 106. The offer-analysis module 230 on the transaction server 106 analyzes the information associated with the items and the consumer's records as described above to identify at least one offer applicable to the items of interest and/or other items relevant thereto. In some embodiments, the transaction server 106 provides the information associated with the items together with the consumer's records to the third-party syndicate members. The third-party syndicate members can formulate offers in real time or participate in real-time bidding as described above. Again, the transaction server 106 may then determine how many and which offers are provided to the consumer. This way, the consumer can obtain the promotional offers right away and determine whether to purchase the items without involving the merchant. In various embodiments, the transaction server 106 transmits the offer(s) to the consumer device 102 in the form of, for example, a coupon or a link that directs the consumer to retrieve the offer(s). In one implementation, the coupon is formatted as a code (such as, a barcode, an RFID code, or a QR code, and/or a signal, such as an NFC signal, an audio signal, or an infrared signal) readable by the reader 114 in the merchant system 110. Therefore, when checking out, the consumer presents the coupon together with the payment token and the items to be purchased to the merchant system 110 to take advantage of the offer(s).

Although the discussion herein focuses on introducing the promotional offers into the flow of a consumer transaction during an in-store checkout via the merchant POS system, the promotions may be provided in an e-commerce checkout. For example, when the consumer adds an item sought to be purchased into a shopping cart, the e-merchant may transmit this information to the transaction server 106; the transaction server 106 then provides applicable offers to the consumer based on the approaches as described above. In one embodiment, the offers and their associated items are automatically added into the consumer's shopping cart; the consumer may accept or deny them by simply keeping the items or removing the items from the shopping cart. In another embodiment, the offers are listed in a new window; the consumer may choose to add the associated items in the shopping cart or ignore them by closing the new window.

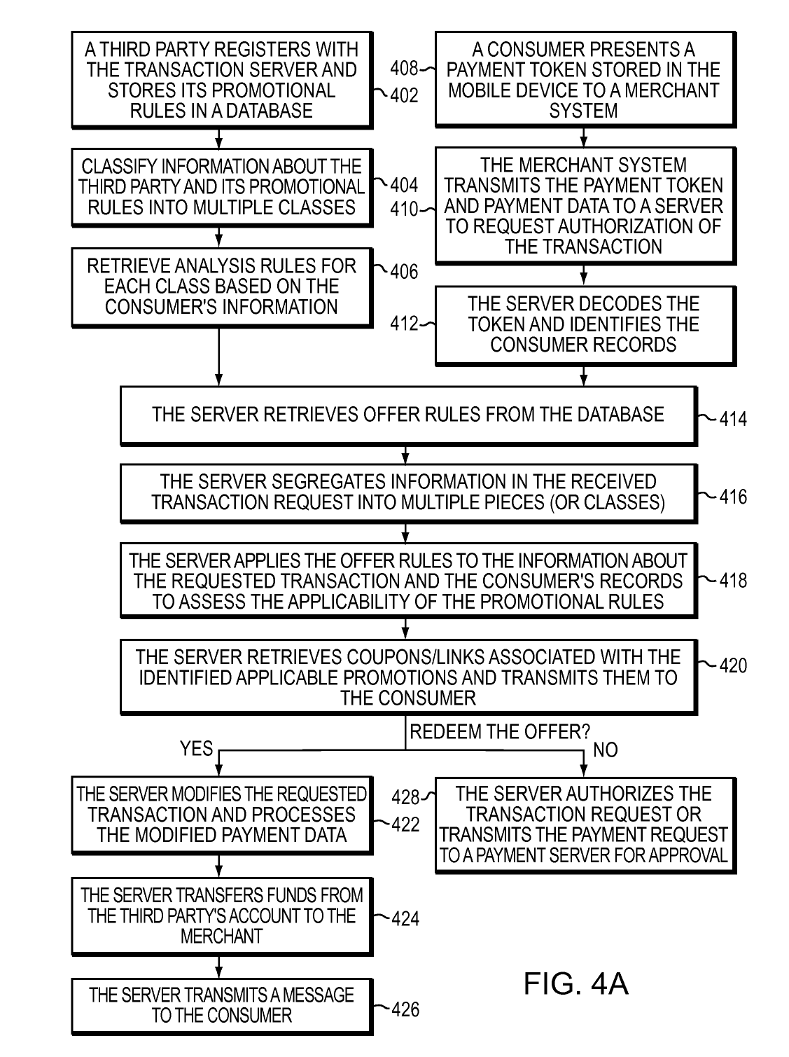

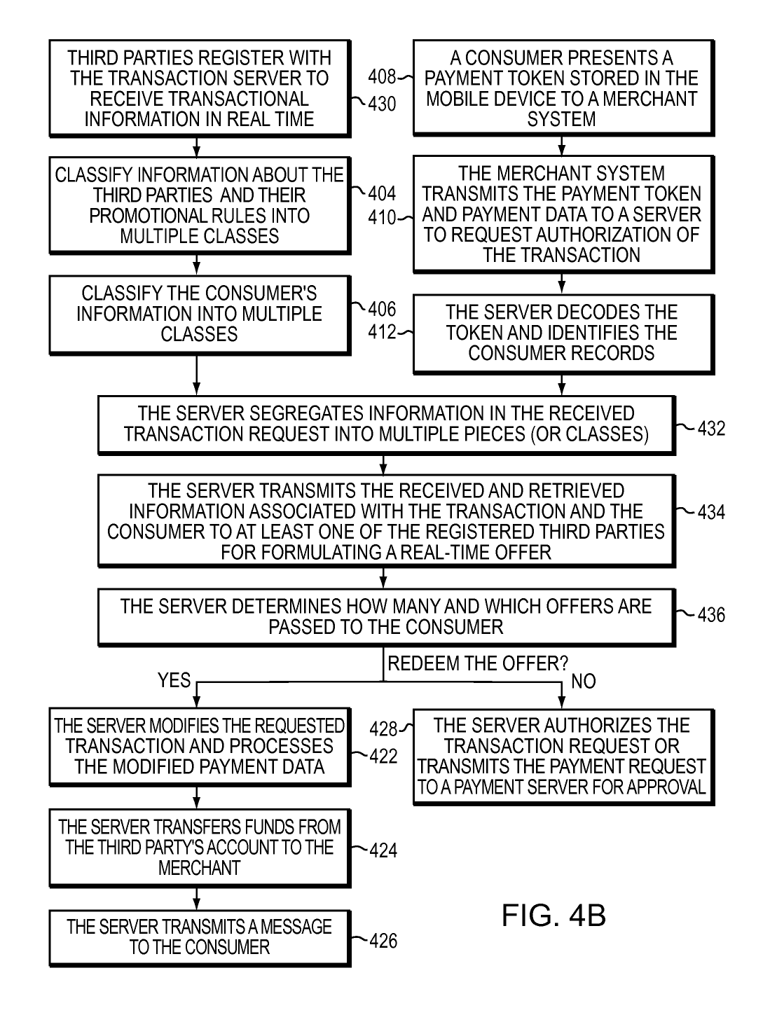

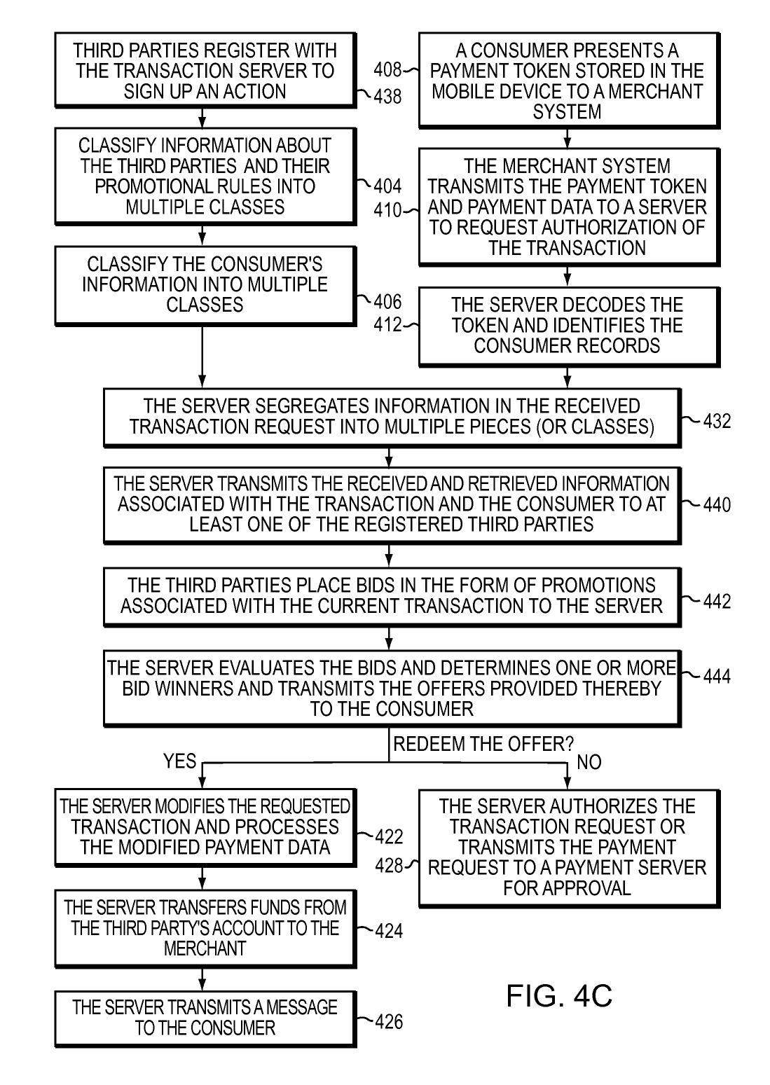

Representative methods for a third party to provide promotional offers to the consumer in accordance with embodiments of the current invention are shown in FIGS. 4A-4C. Referring to FIG. 4A, prior to a payment transaction, the third party may register with the transaction server 106 and store the promotional rules in the offer database 240 (step 402). In some embodiments, information about the third party and its promotional rules is classified into multiple classes (step 404). In addition, the consumer's information is classified into multiple classes (step 406). When the consumer purchases goods or services from a merchant, the consumer initiates a payment transaction by presenting a payment token stored in the mobile device 102 to the merchant system 110 (step 408). The merchant system 110 transmits the payment token and payment data (e.g., purchased item, time, amount, and the name or merchant category code of the merchant) to the transaction server 106 to request authorization of the transaction (step 410). Upon receiving the payment token and data, the transaction server 106 decodes the token to obtain the information therein and identify the consumer based on the decoded information (step 412). The transaction server 106 then retrieves offer rules from the database 240 (step 414). In one embodiment, the transaction server 106 segregates information in the received payment token and payment data into multiple pieces (or classes) (step 416). The transaction server 106 then applies the offer rules to the information in the requested transaction and the consumer's records to assess whether any offers are relevant (step 418). Applicability of the offer rules to the requested transaction may occur on a class-by-class basis. Assuming one or more matches, the transaction server 106 retrieves the corresponding coupons/links associated transmits these to the consumer (step 420). If the consumer chooses to redeem the offers, the transaction server 106 modifies the requested transaction and passes the payment token with the modified payment data to the payment processor 108 for authorization, or in some embodiments, approves the transaction (step 422). Additionally, the transaction server 106 may request the payment server 108 to authorize a payment from the third party's account to the merchant for compensation (step 424). The transaction server 106 then transmits a message to the consumer indicating a successful use of the coupons (step 426). If, however, the consumer chooses not to redeem the offers, the transaction server 106 transmits the originally requested payment data and payment token to the payment server 108 for approval, or in some embodiments, authorizes the payment (step 428).

Referring to FIG. 4B, in some embodiments, the third-party syndicate members register with the transaction server 106 to receive information associated with the current transaction and/or the consumer's records in real time (step 430). In various embodiments, upon receiving the transaction request, the transaction server 106 segregates the received information into multiple pieces (or classes) (step 432). During the transaction, the transaction request is processed in a similar way as described in connection with steps 408-412. In addition, the transaction server 106 transmits the received and retrieved information associated with the transaction and the consumer to one or more of the registered third-party syndicate members for formulating real-time offers (step 434). In one embodiment, the transaction server 106 transmits the transactional information only to some of the members based on the class(es) of data in the transaction request, the classes of the third parties, and the consumer records. The transaction server 106 then determines how many and which offers are passed to the consumer (step 436). Again, the consumer selects or chooses which offer to redeem; based thereon the transaction sever 106 processes the transaction as described in steps 422-428.

Referring to FIG. 4C, in various embodiments, the third parties sign up on the transaction server 106 as participants in an auction (step 438). During a transaction, the transaction server 106 transmits information associated with the current transaction and/or the consumer's records as an auction item to the registered third-party members (step 440). The third-party members then utilize consumer records in identifying prospects for promotions and transmit their bids in the form of promotions associated with the current transaction to the transaction server 106 (step 442). Once again, the transaction server 106 then evaluates the bids and determines one or more bid winners and transmits the offers provided thereby to the consumer (step 444). The consumer can then either claim/redeem or deny the offer (steps 422-428).

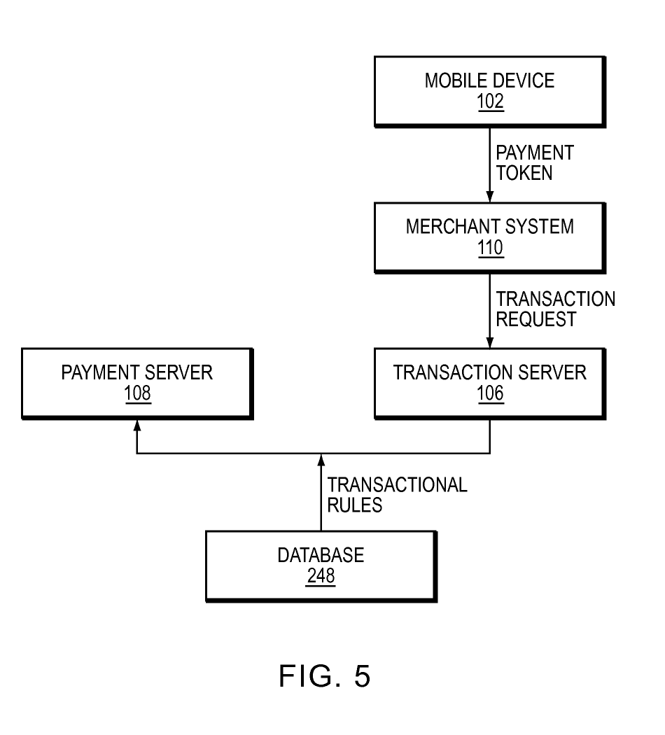

Referring to FIG. 5, in various embodiments, in response to a request for processing a transaction received from the merchant system 110, the transaction server 106 first decodes the payment token presented by the consumer and determines whether the token is restricted. If it is, the transaction server 106 analyzes the transactional details (e.g., items sought to be purchased or transactional amounts) and/or the consumer's records against transactional rules, associated with the consumer, stored in the transactional rule database 248, or in some embodiments, embedded in the payment token to determine whether the requested transaction is consistent with the restrictions defined by the transactional rules. If so, the transaction server 106 subsequently identifies applicable offer(s), communicates the transactional details and the consumer's records to the third parties to formulate offers in real-time and/or assigns one or more offers based on the third-parties bidding as described above; the offer(s) is then provided to the consumer. If, however, the transaction request is inconsistent with the restrictions (i.e., the transactional rules are violated), the transaction server 106 interrupts the transaction or ultimately denies the transaction.

The transactional rules define how the payment token is restricted in terms of where, by whom, to which merchant, or for what the token can be used. For example, the transactional rules may limit the use of the token by business identity (e.g., a particular store or restaurant), by business type (e.g., a movie theater, grocery store, hair salon), by geographic location (e.g., a particular city, state or country), by transaction amount (e.g., the cost of a purchase), by date (e.g., day of the week, month or a particular date), by time (before 7 pm, or between 11 am and 1 pm), by item/service purchase (e.g., groceries, gasoline, etc.), by merchant type (e.g., online or in-store), or by any other transaction characteristics. The transactional rules may be set by the consumer for security purposes or to enable payments to a subordinate (e.g., a child or colleague). For example, the consumer may restrict the payment token to be used only in the country where he resides. In one embodiment, these restrictions are stored in the transactional rule database 248. When the transaction server 106 decodes the payment token to identify the consumer, the restriction-analysis module 231 analyzes whether information associated with the consumer and the requested transaction (e.g., location of placing the purchase) satisfies the transactional rules stored in the database 248. Based thereon, the restriction-analysis module 231 determines whether the transaction request should be processed or interrupted. In another embodiment, the restrictions are directly embedded in the payment token when generated by the token payment process 228. In this case, the transaction server 106 decodes the token to retrieve the restrictions and determines the consistency between the transaction request, the consumer's profile and the decoded restrictions without searching for transactional rules stored in the database. In either case, the consumer may dynamically restrict the use of the payment token by modifying, adding or removing the restrictions. Additionally, assessment of the consistency between the requested transaction, the consumer's records and the restrictions may operate at the “class” level as described above to expedite the analysis.

In various embodiments, the restrictions are set by a third party, such as the consumer's parent or primary health care provider. For example, when a consumer is diagnosed with diabetes, his doctor may restrict his grocery purchases to limit foods that are high in sugar, fat and salt. In another example, a parent may restrict her child who is authorized to use the payment token to purchase only non-alcoholic drinks while underage. Additionally, the transactional rules may be created by the rule generator 232 based on the consumer records stored in the consumer database 246 and/or collected from an external source for security purposes; see, e.g., U.S. Ser. No. 14/107,677, filed on Dec. 16, 2013, the entire disclosure of which is hereby incorporated by reference.

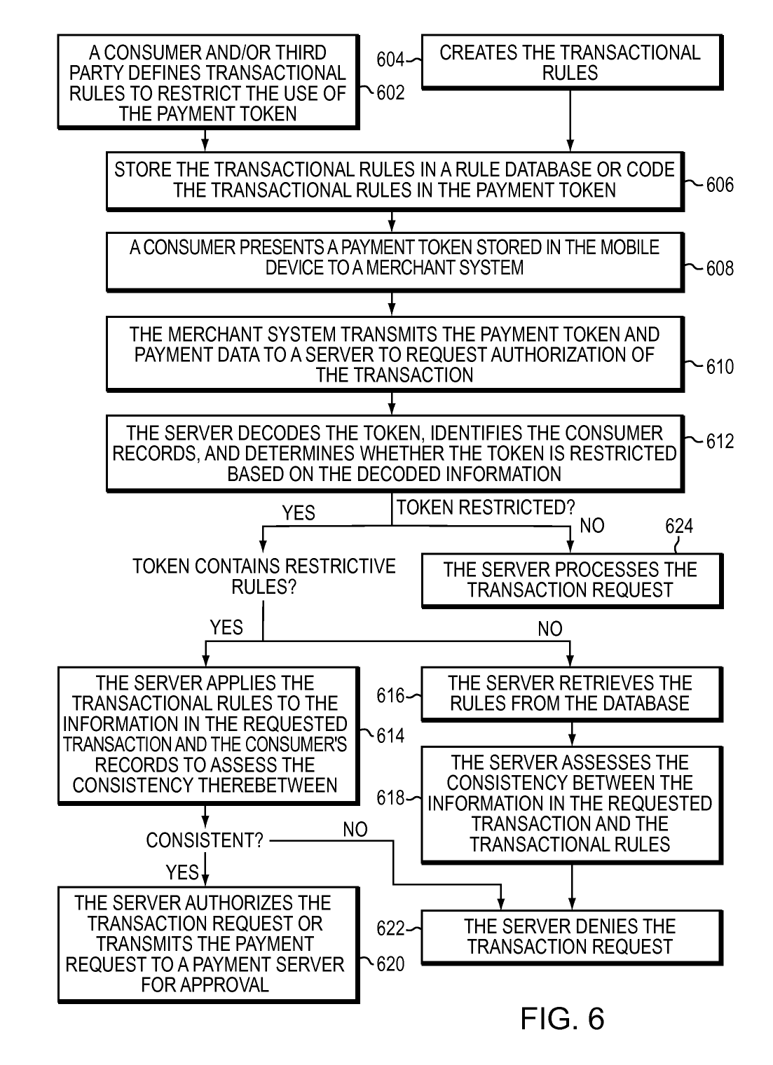

A representative method 600 for applying payment token restrictions in payment transactions in accordance with embodiments of the current invention is shown in FIG. 6. In a first step 602, the consumer and/or third party defines transactional rules to restrict the use of the payment token prior to a payment transaction. In some embodiments, the transactional rules are created by the rule generator 232 based on the consumer records stored in the consumer database 246 and/or collected from an external source (step 604). The transactional rules are then stored in the rule database 248 or coded in the payment token (in the second step 606). During a transaction, the consumer initiates a payment transaction by presenting a payment token to the merchant system 110 (step 608). The merchant system 110 transmits the payment token and payment data to the transaction server 106 to request authorization of the transaction (step 610). Upon receiving the payment token and data, the transaction server 106 decodes the token to identify the consumer and determine whether the token is restricted based on the decoded information (step 612). If the token contains restrictive transactional rules, the transaction server applies the transactional rules to the information in the requested transaction and the consumer's records to assess the consistency therebetween (step 614). If the token is restricted but containing no transactional rules, the transaction server 106 retrieves the rules from the database 248 (step 616) and assesses the consistency between the information in the requested transaction and the transactional rules (step 618). If the transactional rules are satisfied, the transaction server 106 passes the transaction request to the payment server 108 for authorization or, in some embodiments, approves the transaction (step 620). If, however, the transactional rules are violated, the transaction server 106 denies the transaction request (step 622). If the token is not restricted, the transaction server 106 passes the transaction request to the payment server 108 for approval, or in some embodiments, grants the request (step 624). In one embodiment, the transaction server 106 classifies the transactional rules and the consumer's information into multiple classes. In addition, upon receiving the transaction request, the transaction server 106 segregates the received information into multiple pieces (or classes). Analysis of consistency between the requested transaction and the transactional rules can then be evaluated on a class-by-class basis.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. For example, the approach used to check consistency between the received transaction payment and the transactional rules may not be unique. Any conventional approach suitable for recognizing consistency between multiple data sets may be implemented in the application of restricting the payment token usage in transactions and therefore is within the scope of the current application. In addition, the transaction payment may not be necessarily conducted using a mobile device. Transactions may be initiated using any device (e.g., an automated teller machines (ATM)) and any payment token (e.g., a credit card) presented in person or remotely to the merchant system. More generally, those skilled in the art will readily appreciate that all configurations described herein are meant to be exemplary and that the actual configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, and/or method described herein. In addition, any combination of two or more such features, systems, articles, and/or methods, if such features, systems, articles, and/or methods are not mutually inconsistent, is included within the inventive scope of the present disclosure.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. In addition, the terms like “user device,” “mobile,” “communication device,” and similar terminology, refer to a wireless device (e.g., cellular phone, smart phone, computer, PDA, set-top box, Internet Protocol Television (IPTV), electronic gaming device, printer, and so forth) utilized by a user of a wireless communication service to receive or convey data, control, voice, video, sound, gaming, or substantially any data-stream or signaling-stream. The foregoing terms are utilized interchangeably in the subject specification and related drawings. The terms “component,” “system,” “platform,” “module,” and the like refer broadly to a computer-related entity or an entity related to an operational machine with one or more specific functionalities. Such entities can be hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

The processor 206, 222 that execute commands and instructions may be a general purpose computer, but may utilize any of a wide variety of other technologies including a special purpose computer, a microcomputer, minicomputer, mainframe computer, programmed microprocessor, micro-controller, peripheral integrated circuit element, a CSIC (customer-specific integrated circuit), ASIC (application-specific integrated circuit), a logic circuit, a digital signal processor, a programmable logic device, such as an FPGA (field-programmable gate array), PLD (programmable logic device), PLA (programmable logic array), RFID processor, smart chip, or any other device or arrangement of devices that is capable of implementing the steps of the processes of the invention.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, code or process) include machine instructions for a programmable processor, and can be implemented in a high-level procedural and/or object-oriented programming language, and/or in assembly/machine language.

The storage devices 242, 244 may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft WINDOWS operating system, the UNIX operating system, the LINUX operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system of platform.

The storage devices 242, 244 may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods and techniques described herein. For example, various forms of the flows shown above may be used, with steps re-ordered, added, or removed. Accordingly, other implementations are within the scope of the following claims.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A method of electronically providing promotional offers to a consumer at a point of sale, the method comprising steps of, at a server computer including a processor:
electronically receiving, from a merchant device via a communication network, a consumer-originated transaction request for processing payment to complete the transaction;
electronically transmitting, in real time by the processor via the communication network to a plurality of devices of third parties registered with the server following the transaction request, information contained in the transaction request to enable the third parties to formulate promotional offers; and
responsively to the previously transmitted information, receiving, electronically via the computer network, the promotional offers from the third-party devices and subsequently transmitting, by the processor via the communication network, at least one of the offers to a mobile device associated with the consumer.

2. The method of claim 1, wherein the transmitting step occurs prior to electronically sending the transaction request to a payment processor.

3. The method of claim 1 wherein, if the consumer chooses to redeem the at least one offer via the merchant device, modifying the transaction request based thereon before electronically sending the transaction request to a payment processor.

4. The method of claim 1, wherein information from records associated with the consumer is sent to the plurality of third parties along with information contained in the transaction request.

5. The method of claim 1, wherein the transaction request comprises a transaction amount and the promotional offers comprise reducing the transaction amount.

6. The method of claim 5, further comprising the step of compensating the merchant by:
identifying the third party associated with the promotional offer redeemed by the consumer; and
causing transfer of funds from a financial account associated with the identified third party to the merchant.

7. The method of claim 1, further comprising computationally analyzing the received promotional offers according to a set of auction rules, the at least one offer transmitted to the mobile device being selected based on the analysis.

8. The method of claim 7, wherein the auction rules cause selection of a promotional offer based on at least one of (i) a discount amount, (ii) conflicts between the offers, (iii) a likelihood of offer redemption, (iv) a likelihood of affecting the consumer's future purchasing behavior, or (v) economic benefits to the consumer, the merchant, and/or a party hosting the server.

9. The method of claim 4, further comprising:
classifying the third parties and the consumer records into a plurality of classes;
classifying data in the transaction request into at least one class; and
transmitting information contained in the transaction request and records associated with the consumer to only some of the plurality of the third parties based on the at least one class of data in the transaction request, the plurality of the third party classes, and the consumer records.

10. (canceled)

11. (canceled)

12. The method of claim 1, wherein the transaction request comprises a payment token and the method further comprises, at the merchant device:
decoding the payment token to determine whether the token is restricted;
determining consistency between information contained in the transaction request and restrictions associated with the payment token; and
based on the determined consistency, processing or denying the transaction request.

13. A method of electronically providing promotional offers to a consumer making a purchase transaction at a point of sale and involving one or more items, the method comprising steps of:
storing, in a database of an offer server, a plurality of records associated with a plurality of offerors, each of the records comprising at least one promotion and a set of trigger criteria associated therewith;
electronically receiving, from a merchant device of a merchant at the point of sale, data specifying elements of the purchase transaction;
identifying at least one promotion sponsored by an offeror other than the merchant by querying the database using the received data, the trigger criteria of the at least one identified promotion being satisfied by the specified elements of the purchase transaction;
causing the at least one identified promotion to be transmitted to a mobile device associated with the consumer;
receiving from the mobile device of the consumer information identifying at least one selected promotion from said at least one identified promotion transmitted to the mobile device; and
applying the selected promotion to modify the transaction prior to submitting the transaction to a payment server.

14. The method of claim 13, wherein the elements comprise items purchased and price.

15. The method of claim 13, wherein the received data also includes information from records associated with the consumer.

16. A server for electronically providing promotional offers to a consumer at a point of sale, the server comprising:
a first database for storing records associated with the consumer and a second database for storing records associated with a plurality of third parties registered therewith;
a communication module configured for communication over a computer network; and
a processor configured to:
electronically receive, via the communication module from a merchant device over the computer network, a consumer-originated transaction request for processing payment to complete the transaction;
electronically transmit, in real time via the communication module to a plurality of registered third-party devices over the computer network following the transaction request, information contained in the transaction request to enable the third parties to formulate promotional offers; and
responsively to the previously transmitted information, electronically receive, via the communication module over the computer network, the promotional offers from the third-party devices and subsequently cause transmission, via the communication module over the computer network, of at least one of the offers to a mobile device associated with the consumer.

17. The server of claim 16, wherein the processor is configured to cause transmission, via the communication module, of information to the third parties prior to transmission of the transaction request to a payment processor.

18. The server of claim 16, wherein the processor is configured, upon receipt by the communication of a signal indicating a choice by the consumer to redeem the at least one offer via the merchant device, to modify the transaction request based thereon before causing transmission of the transaction request to a payment processor.

19. The server of claim 16, wherein the processor is configured to cause transmission of information from records associated with the consumer to the plurality of third parties along with information contained in the transaction request.

20. The server of claim 16, wherein the processor is further configured to compensate the merchant by:
identifying the third party associated with the promotional offer redeemed by the consumer; and
causing transfer of funds from a financial account associated with the identified third party to the merchant.

21. The server of claim 16, further comprising a memory for storing a set of auction rules, the processor being further configured to computationally analyze the received promotional offers according to the auction rule, the at least one offer transmitted to the mobile device being selected based on the analysis.

22. The server of claim 21, wherein execution of the auction rules by the processor causes selection of a promotional offer based on at least one of (i) discount amount, (ii) conflicts between the offers, (iii) a likelihood of offer redemption, (iv) a likelihood of affecting the consumer's future purchasing behavior, or (v) economic benefits to the consumer, the merchant, and/or a party hosting the server.

23. The server of claim 16, wherein the processor is further configured to:
classify the third parties and the consumer records into a plurality of classes;
classify data in the transaction request into at least one class; and
transmit information contained in the transaction request and records associated with the consumer to only some of the plurality of the third parties based on the at least one class of data in the transaction request, the plurality of the third party classes, and the consumer records.

24. (canceled)

25. (canceled)

26. The server of claim 16, wherein the transaction request comprises a payment token and the processor is further configured to:
decode the payment token to determine whether the token is restricted;
determine consistency between information contained in the transaction request and restrictions associated with the payment token; and
based on the determined consistency, process or deny the transaction request.

27. A server for electronically providing promotional offers to a consumer making a purchase transaction at a point of sale and involving one or more items, the server comprising:
a database for electronically storing a plurality of records associated with a plurality of offerors, each of the records comprising at least one promotion and a set of trigger criteria associated therewith;
a communication module; and
a processor configured to:
electronically receive, via the communication module from a merchant device of a merchant at the point of sale, data specifying elements of the purchase transaction;
identify at least one promotion sponsored by an offeror other than the merchant by querying the database using the received data, the trigger criteria of the at least one identified promotion being satisfied by the specified elements of the purchase transaction;
cause the at least one identified promotion to be transmitted, via the communication module, to a mobile device associated with the consumer;
receive from the mobile device of the consumer information identifying at least one selected promotion from said at least one identified promotion transmitted to the device; and
apply the selected promotion to modify the transaction prior to submitting the transaction to a payment server.

28. The server of claim 27, wherein the elements comprise items purchased and price.

29. The server of claim 28, wherein the received data also includes information from records associated with the consumer.
